(19) United States
(12) Patent Application Publication
(10) Pub. No.: US 2009/0293532 A1
(43) Pub. Date: Dec. 3, 2009

(54) BEVERAGE CARRIER

(76) Inventors: Nabil Najjar, Manhattan Beach, CA (US); Steve Sax, Beverly Hills, CA (US)

Correspondence Address: DAVIS WRIGHT TREMAINE LLP/Los Angeles, 865 FIGUEROA STREET, SUITE 2400, LOS ANGELES, CA, 90017-2566, US

(21) Appl. No.: 12/131,769

(22) Filed: Jun. 2, 2008

(51) Int. Cl. A47J 39/00; F25D 3/08

(52) U.S. Cl. 62/457.7; 220/592.2; 220/288; 220/628; 220/752; 220/592.18; 206/459.5

(57) ABSTRACT

Various embodiments of the invention relate to a beverage carrier in the shape of a ball associated with a sport or sporting activity. The beverage carrier may include one or more handles, a cover and a base. It may be configured to contain and dispense a beverage or to house a number of beverage containers. It may be configured to maintain a desired temperature for the beverage(s) carried therein. It may incorporate an advertisement on its exterior, for use in promoting a company, brand, event or the like.

### FIELD OF THE INVENTION

The invention relates to the field of beverage carriers; specifically, to carriers configured to contain a beverage or containers of beverages, and to maintain the temperature of the beverage(s).

### BRIEF DESCRIPTION OF THE DRAWINGS

Exemplary embodiments are illustrated in referenced figures. It is intended that the embodiments and figures disclosed herein are to be considered illustrative rather than restrictive.

FIG. 1 depicts a front elevation view of a beverage carrier with a fluid dispensing mechanism, in accordance with an embodiment of the present invention.

FIG. 2 depicts a side elevation view of the beverage carrier of FIG. 1, in accordance with an embodiment of the present invention.

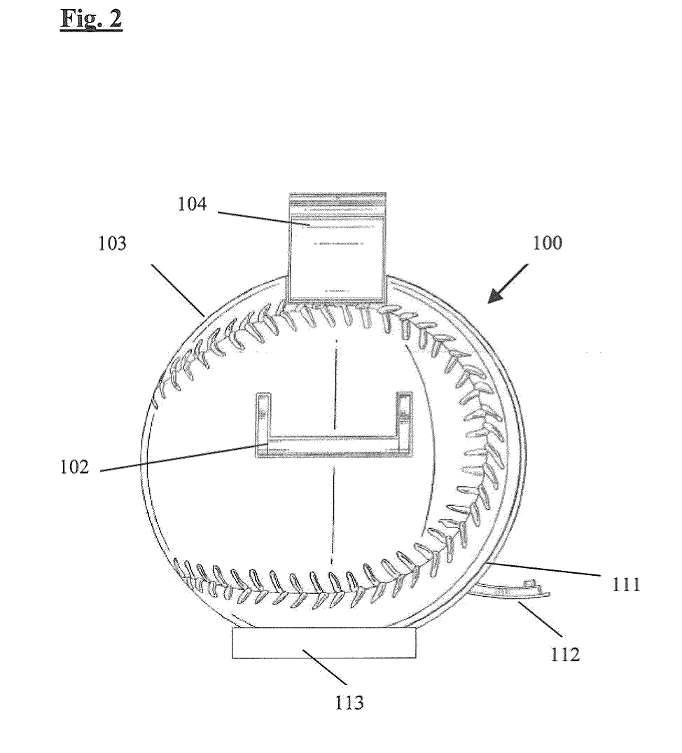

FIG. 3 depicts a cross-sectional view of the beverage carrier of FIG. 1, in accordance with an embodiment of the present invention.

FIG. 4 depicts a front elevation view of a beverage carrier configured to house one or more beverage containers, in accordance with an embodiment of the present invention.

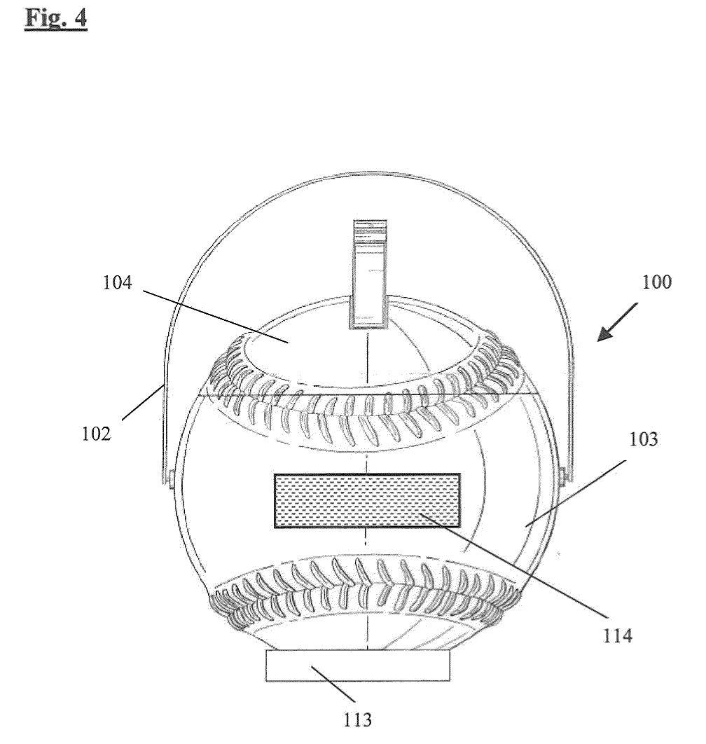

FIG. 5 depicts a side elevation view of the beverage carrier of FIG. 4, in accordance with an embodiment of the present invention.

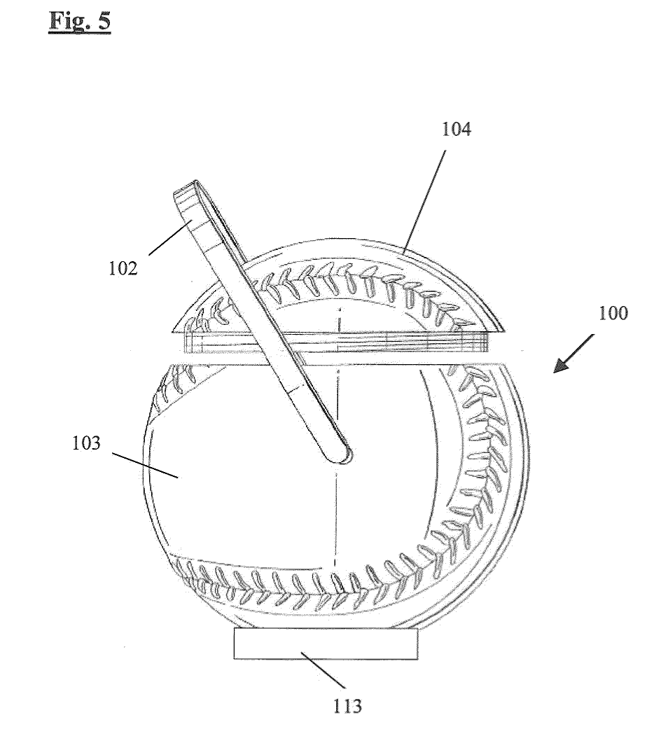

FIG. 6 depicts a cross-sectional view of the beverage carrier of FIG. 4, in accordance with an embodiment of the present invention.

### DETAILED DESCRIPTION

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

One skilled in the art will recognize many methods and materials similar or equivalent to those described herein, which could be used in the practice of the present invention. Indeed, the present invention is in no way limited to the methods and materials described.

The invention relates to a beverage carrier in the shape of a ball. In various embodiments, the ball upon which the beverage carrier is modeled may be a soccer ball, tennis ball, baseball, football, basketball, golf ball, ping pong ball, bowling ball, volleyball or any other ball associated with a particular sport or sporting activity. The exterior of the carrier is thus shaped as a ball associated with a particular sport or sporting activity. The interior of the carrier includes various components and materials that render the carrier suitable for containing and/or transporting a quantity of a beverage or for containing and/or transporting one or more containers containing a beverage, and, in some embodiments, for maintaining the temperature of the beverage; for instance, for keeping the beverage chilled.

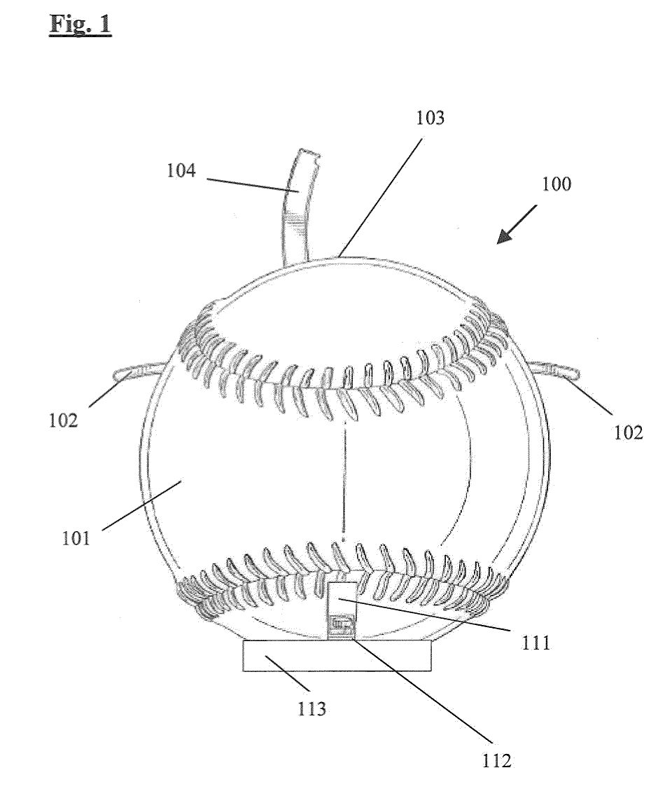

As illustrated in FIG. 1, in one embodiment a beverage carrier 100 includes an exterior 101 in the shape of a ball. The ball may be associated with a particular sport or sporting activity. In the embodiments of the invention illustratively depicted herein, the ball is a baseball. As will be readily appreciated by those of skill in the art, the inventive beverage carriers can take the shape of any number of balls. In some embodiments, such balls are spherical, but in other embodiments (e.g., where the ball is an American football), they are not. Examples of balls include, but are not limited to, soccer balls, tennis balls, baseballs, footballs, basketballs, golf balls, ping pong balls, bowling balls, volleyballs or any other ball associated with a particular sport or sporting activity. The exterior 101 may include a substantially flat surface (not shown) on its bottom such that the beverage carrier 100 remains upright when set on a correspondingly flat surface. Alternatively, the beverage carrier 100 may include a base unit 113 to keep the beverage carrier 100 positioned upright when placed on a surface.

The exterior 101 of the beverage carrier 100 may further include one or more handles 102, to enable a user to, among other things, easily transport and/or lift the beverage carrier 100. The handle 102 may be positioned on top (not shown) of the beverage carrier 100. In alternate embodiments of the invention, the one or more handles 102 may be included on the sides of the beverage carrier 100; for instance, positioned opposite and/or equidistant from one another about the circumference of the beverage carrier 100. Those of skill in the art will recognize a wide array of handle configurations that may be incorporated in still further embodiments of the invention.

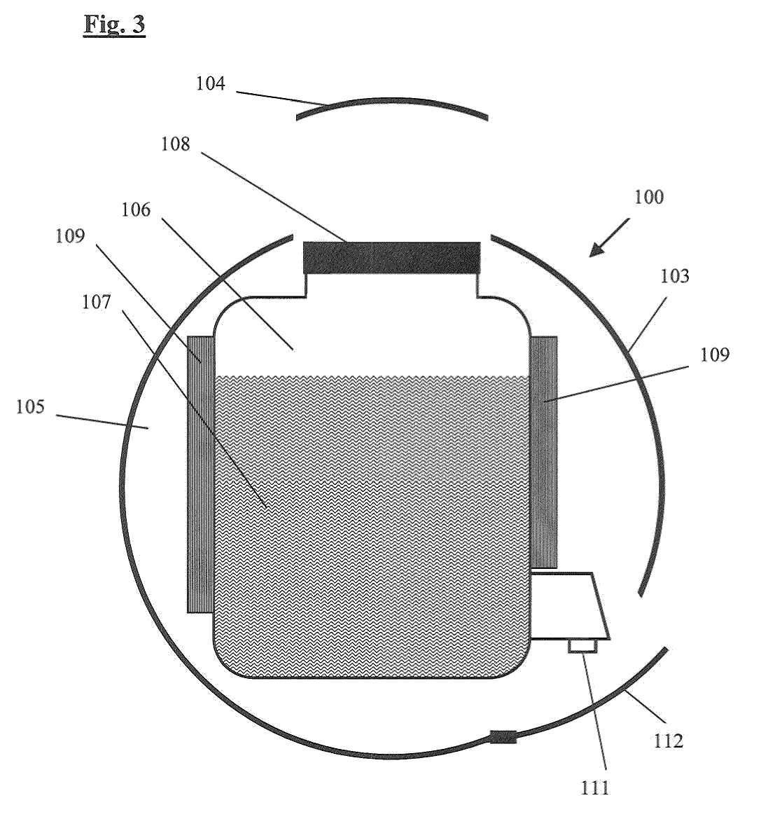

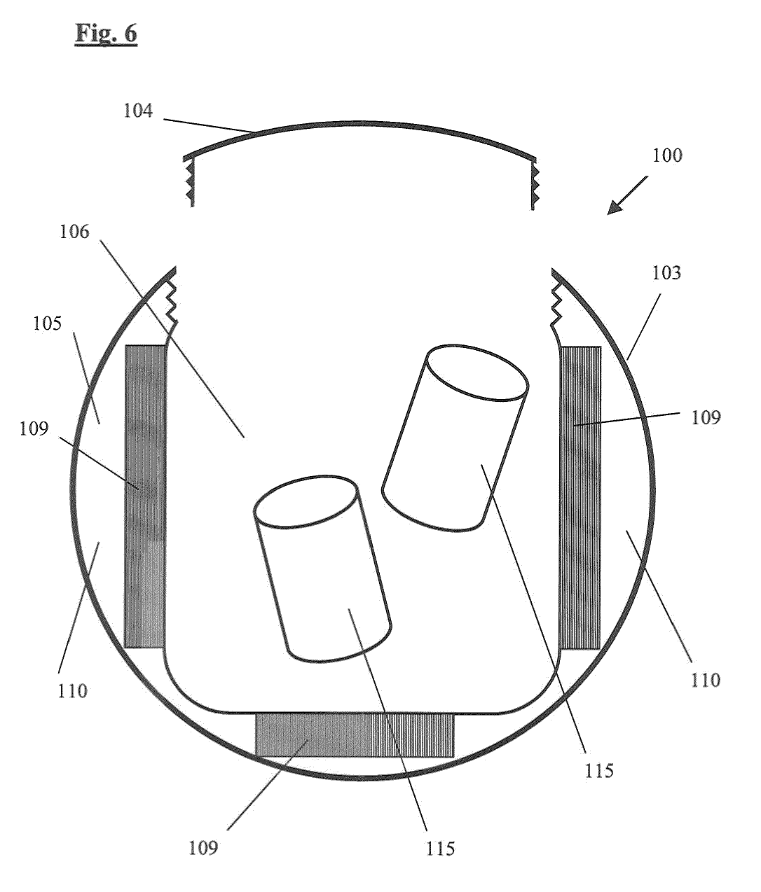

The exterior 101 of the beverage carrier 100 may further include an opening 103 through which the beverage 107 to be contained therein may be introduced and/or removed. The opening 103 may be configured in any desirable shape or size. The interior 105 of the beverage carrier 100 may include a chamber 106 configured to either contain the beverage 107 (FIG. 3) or to house one or more containers 115 that contain a beverage (e.g., soda cans, water bottles, milk cartons, etc.) (FIG. 6). In either case, the chamber 106 is in communication with the opening 103.

In some embodiments of the invention, the opening 103 may include a cover 104. The cover 104 may be removably attached to the exterior 101 of the beverage carrier 100 at or near the opening 103 by a suitable closure mechanism, such as screw threading, a series of tongue-and-groove assemblages, a pressure fitting or a mechanical lock. In an alternate embodiment, the cover 104 is affixed to the exterior 101 of the beverage carrier 100 at or near the opening 103 by a hinge or other closure mechanism, as will be readily apparent to those of skill in the art. In some embodiments, when the cover 104 is closed, it is in direct communication with the beverage 107 contained within the chamber 106. In other embodiments, a cap 108 is included to provide a fluid-tight seal for the chamber 106, and in such embodiments, the cover 104 does not serve to contain the beverage in the chamber 106. The cap 108 may removably engage with the chamber 106 by any suitable mechanism, such as, by way of example, screw threading, a series of tongue-and-groove assemblages, a pressure fitting or a mechanical lock.

In further embodiments of the invention, surrounding the chamber 106 is an assemblage of components and/or materials configured to retain the temperature of the beverage 107 contained therein, whether such beverage 107 is contained in the chamber 106 or housed in a series of one or more containers that are placed in the chamber 106. In one such embodiment, one or more layers of insulating material 109 surround the chamber 106. In another embodiment, the interior 105 includes a cavity 110 in which cooling material, such as ice or one or more cold packs (e.g., containing ammonium-nitrate fertilizer and water), may be included.

In further embodiments of the invention, a fluid dispensing mechanism 111 is included. The fluid dispending mechanism 111 is in fluid communication with the chamber 106, such that actuation of the fluid dispensing mechanism releases the beverage 107 from the chamber 106. A variety of fluid dispensing mechanisms 11 may be used in connection with alternate embodiments of the invention; for instance, a conventional spigot operated by either a button or a lever. A dispenser door 112 may be included on the exterior 101 of the beverage carrier 100 to conceal the fluid dispensing mechanism 111 when not in use. The dispenser door 112 may be either removably affixed to the exterior 101 or attached thereto by a hinge or similar mechanism that enables a user to access the fluid dispensing mechanism 111 and dispense the beverage 107 while the dispenser door 112 remains attached to the exterior 101.

In further embodiments of the invention, an advertisement 114 may be included on the exterior 101 of the beverage carrier 100. The advertisement 114 may take the form of a corporate name and/or logo, a brand name and/or logo, the name and/or logo associated with an event (e.g., a sporting event) or any number of other items as will be readily appreciated by those of skill in the art. The advertisement 114 may be placed at any one or more suitable locations on the exterior 101 of the beverage carrier 100 to promote a company, a brand, an event or the like, respectively. As such, in one embodiment, the invention includes a method of promoting a company, brand, event or the like by providing a beverage carrier 100 and including on it an advertisement 114 associated with the company, brand, event or the like, respectively. The method may further include providing such beverage carriers 100 at an event, such as a sporting event. Those skilled in the art will recognize many ways in which to use the inventive beverage carrier 100 to promote the subject of an advertisement 114 included thereupon.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

The foregoing description of various embodiments of the invention known to the applicant at this time of filing the application has been presented and is intended for the purposes of illustration and description. The present description is not intended to be exhaustive nor limit the invention to the precise form disclosed and many modifications and variations are possible in the light of the above teachings. The embodiments described serve to explain the principles of the invention and its practical application and to enable others skilled in the art to utilize the invention in various embodiments and with various modifications as are suited to the particular use contemplated. Therefore, it is intended that the invention not be limited to the particular embodiments disclosed for carrying out the invention.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

What is claimed is:

1. A beverage carrier, comprising:
an exterior in the shape of a ball associated with a sport or sporting activity;
an opening in the exterior to provide access to a chamber in an interior of the beverage carrier; and
a cover in mechanical communication with the opening to conceal the interior when the cover is in a closed position,
wherein the chamber is adapted to contain either a beverage or at least one beverage container containing the beverage.

2. The beverage carrier of claim 1, wherein the ball is a soccer ball, a tennis ball, a baseball, a football, a basketball, a golf ball, a ping pong ball, a bowling ball or a volleyball.

3. The beverage carrier of claim 1, further comprising means to maintain a temperature of the beverage.

4. The beverage carrier of claim 3, wherein said means to maintain a temperature of the beverage is selected from the group consisting of one or more layers of insulating material surrounding the chamber, a cavity configured to receive a cooling material, and combinations thereof.

5. The beverage carrier of claim 1, further comprising one or more handles configured on the exterior of the beverage carrier.

6. The beverage carrier of claim 1, further comprising a base unit to keep the beverage carrier positioned upright when placed on a surface.

7. The beverage carrier of claim 1, wherein the exterior comprises a substantially flat surface on its bottom.

8. The beverage carrier of claim 1, further comprising a cap removably attached to the chamber.

9. The beverage carrier of claim 1, further comprising a fluid dispensing mechanism in fluid communication with the chamber.

10. The beverage carrier of claim 9, further comprising a dispenser door attached to the exterior and configured to conceal the fluid dispensing mechanism when the fluid dispensing mechanism is not in use.

11. The beverage carrier of claim 1, further comprising an advertisement configured on the exterior.

12. The beverage carrier of claim 11, wherein the advertisement promotes a company, a brand, an event or a combination thereof.

13. A method of transporting a beverage or at least one beverage container containing the beverage, comprising:
providing a beverage carrier, comprising:
an exterior in the shape of a ball associated with a sport or sporting activity,
an opening in the exterior to provide access to a chamber in an interior of the beverage carrier, and
a cover in mechanical communication with the opening to conceal the interior when the cover is in a closed position,
wherein the chamber is adapted to contain either the beverage or at least one beverage container containing the beverage;
providing the beverage or at least one beverage container containing the beverage in the chamber; and
transporting the beverage or at least one beverage container containing the beverage in the beverage carrier.

14. The method of claim 13, wherein the ball is a soccer ball, a tennis ball, a baseball, a football, a basketball, a golf ball, a ping pong ball, a bowling ball or a volleyball.

15. The method of claim 13, wherein the beverage carrier further comprises means to maintain a temperature of the beverage.

16. The method of claim 15, wherein said means to maintain a temperature of the beverage is selected from the group consisting of one or more layers of insulating material surrounding the chamber, a cavity configured to receive a cooling material, and combinations thereof.

17. The method of claim 13, wherein the beverage carrier further comprises one or more handles configured on the exterior of the beverage carrier.

18. The method of claim 13, wherein the beverage carrier further comprises a fluid dispensing mechanism in fluid communication with the chamber.

19. The method of claim 13, wherein the beverage carrier further comprises an advertisement configured on the exterior.

20. A method of promoting a company, a brand or an event, comprising:
providing a beverage carrier, comprising:
an exterior in the shape of a ball associated with a sport or sporting activity,
an opening in the exterior to provide access to a chamber in an interior of the beverage carrier,
a cover in mechanical communication with the opening to conceal the interior when the cover is in a closed position, and
an advertisement configured on the exterior, the advertisement promoting the company, the brand or the event,
wherein the chamber is adapted to contain either the beverage or at least one beverage container containing the beverage; and
using the beverage carrier in a manner that promotes the company, the brand or the event.
